(19) United States
(12) Patent Application Publication
(10) Pub. No.: US 2026/0324754 A1
(43) Pub. Date: Oct. 22, 2026

(54) AEROSOL PROVISION SYSTEM

(71) Applicant: NICOVENTURES TRADING LIMITED, London (GB)

(72) Inventors: Dean COWAN, Shenzhen (CN); Chi Wai FUNG, Shenzhen (CN); Dongyang LIN, London (GB); Hanliang CHEN, London (GB)

(21) Appl. No.: 19/728,931

(22) Filed: Jul. 2, 2026

Related U.S. Application Data
(63) Continuation of application No. 19/103,890, filed on Aug. 15, 2023.

(30) Foreign Application Priority Data
Aug. 15, 2022 (GB) 2211917.6
Nov. 22, 2022 (CN) 2022114648796
Feb. 15, 2023 (GB) 2302163.7

(51) Int. Cl. A24F 40/90; A24F 40/53; H02J 7/70; H02J 7/90

(52) U.S. Cl. CPC A24F 40/90; A24F 40/53; H02J 7/70; H02J 7/933

(57) ABSTRACT

An aerosol provision system including: an aerosol provision device having a first controller and a first electrical energy storage device; a charging unit for charging the aerosol provision device, the charging unit having a second controller and a second electrical energy storage device; wherein the first controller and/or the second controller is arranged to determine a connection status between the aerosol provision device and the charging unit and to cause the aerosol provision device to enter into a mode of operation in accordance with a number of options. Also provided is a method of operating an aerosol provision system, an aerosol provision device and a charging unit.

### CROSS-REFERENCE TO RELATED APPLICATIONS

The present application is a Continuation of U.S. Patent Application No. 19/103,890 filed Feb. 14, 2025, which is a National Phase entry of PCT Application No. PCT/EP2023/072477 filed Aug. 15, 2023, which claims priority to GB Application No. 2211917.6 filed Aug. 15, 2022, and CN Application No. 2022114648796 filed Nov. 22, 2022, and GB Application No. 2302163.7 filed Feb. 15, 2023, all of which are hereby incorporated by reference in their entirety.

### TECHNICAL FIELD

The present invention relates to an aerosol provision system, a method of operating an aerosol provision system, an aerosol provision device and a charging unit.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium. Conventional aerosol provision devices comprise a cylindrical heating chamber into which a rod shaped consumable is inserted.

It is known to provide an aerosol provision system comprising an aerosol provision device and a charging unit.

It is desired to provide an improved aerosol provision system.

### SUMMARY

According to an aspect there is provided an aerosol provision system comprising: an aerosol provision device comprising a first controller and a first electrical energy storage device;
a charging unit for charging the aerosol provision device, the charging unit comprising a second controller and a second electrical energy storage device,
wherein the first controller and/or the second controller is arranged to determine a connection status between the aerosol provision device and the charging unit and to cause the aerosol provision device to enter into a mode of operation wherein either option (A) and/or option (B) and/or option (C) and/or option (D) and/or option (E) below apply:
wherein according to option (A) if the first controller and/or second controller determines that the aerosol provision device is electrically connected to the charging unit then the first controller and/or second controller is arranged to cause the aerosol provision device to enter a first mode of operation wherein the aerosol provision device is energized by the second electrical energy storage device in order to commence and optionally complete a first session of use;
wherein according to option (B) if the first controller determines that the aerosol provision device is not electrically connected to the charging unit then the first controller is arranged to cause the aerosol provision device to enter a second mode of operation wherein the aerosol provision device is energized by the first electrical energy storage device;
wherein according to option (C) if the first controller and/or second controller determines that the aerosol provision device is electrically connected to the charging unit then the first controller and/or second controller is arranged to cause the aerosol provision device to enter a third mode of operation wherein the aerosol provision device is energized by the second electrical energy storage device in order to commence a first session of use at a time t1;wherein the first controller is further configured to determine that the aerosol provision device is then subsequently electrically disconnected from the charging unit at a later time t2 during the first session of use and then to cause the aerosol provision device to be energized by the first electrical storage device;
wherein according to option (D) if the first controller determines that the aerosol provision device is not electrically connected to the charging unit then the first controller is arranged to cause the aerosol provision device to enter a fourth mode of operation wherein the aerosol provision device is energized by the first electrical energy storage device in order to commence a first session of use at a time t3;
wherein either the first controller and/or the second controller is arranged to determine that the aerosol provision device is then subsequently electrically connected to the charging unit at a later time t4 during the first session of use and then either: (a) to cause the aerosol provision device to be at least partially energized by the second electrical storage device in order to continue and optionally complete the first session of use; or (b) to cause the aerosol provision device to be energized by the first electrical storage device.;
wherein according to option (E) if the first controller determines that the aerosol provision device is not electrically connected to the charging unit then the first controller is arranged to cause the aerosol provision device to enter a fifth mode of operation wherein the aerosol provision device is energized by the first electrical energy storage device in order to commence a session of use;
if the first controller and/or second controller determines that the aerosol provision device is electrically connected to the charging unit at a later time during the session of use, the first controller is arranged to control the first electrical energy storage device to continue energizing the aerosol provision device.

According to various embodiments an aerosol provision device may be provided wherein just one of options (A), (B), (C), (D) and (E) are provided.

For example, an aerosol provision device may be provide comprising either option (A), option (B), option (C), option (D) or option (E).

For example, according an embodiment there is provided an aerosol provision system comprising:
an aerosol provision device comprising a first controller and a first electrical energy storage device;
a charging unit for charging the aerosol provision device, the charging unit comprising a second controller and a second electrical energy storage device;
wherein the first controller and/or the second controller is arranged to determine a connection status between the aerosol provision device and the charging unit and to cause the aerosol provision device to enter into a mode of operation wherein:

(A) if the first controller and/or second controller determines that the aerosol provision device is electrically connected to the charging unit then the first controller and/or second controller is arranged to cause the aerosol provision device to enter a first mode of operation wherein the aerosol provision device is energized by the second electrical energy storage device in order to commence and optionally complete a first session of use.

According to another embodiment there is provided an aerosol provision system comprising:
an aerosol provision device comprising a first controller and a first electrical energy storage device;
a charging unit for charging the aerosol provision device, the charging unit comprising a second controller and a second electrical energy storage device;
wherein the first controller and/or the second controller is arranged to determine a connection status between the aerosol provision device and the charging unit and to cause the aerosol provision device to enter into a mode of operation wherein:

(B) if the first controller determines that the aerosol provision device is not electrically connected to the charging unit then the first controller is arranged to cause the aerosol provision device to enter a second mode of operation wherein the aerosol provision device is energized by the first electrical energy storage device.

According to another embodiment there is provided an aerosol provision system comprising:
an aerosol provision device comprising a first controller and a first electrical energy storage device;
a charging unit for charging the aerosol provision device, the charging unit comprising a second controller and a second electrical energy storage device;
wherein the first controller and/or the second controller is arranged to determine a connection status between the aerosol provision device and the of operation wherein:

(C) if the first controller and/or second controller determines that the aerosol provision device is electrically connected to the charging unit then the first controller and/or second controller is arranged to cause the aerosol provision device to enter a third mode of operation wherein the aerosol provision device is energized by the second electrical energy storage device in order to commence a first session of use at a time t1;
wherein the first controller is further configured to determine that the aerosol provision device is then subsequently electrically disconnected from the charging unit at a later time t2 during the first session of use and then to cause the aerosol provision device to be energized by the first electrical storage device.

According to another embodiment there is provided an aerosol provision system comprising:
an aerosol provision device comprising a first controller and a first electrical energy storage device;
a charging unit for charging the aerosol provision device, the charging unit comprising a second controller and a second electrical energy storage device;
wherein the first controller and/or the second controller is arranged to determine a connection status between the aerosol provision device and the charging unit and to cause the aerosol provision device to enter into a mode of operation wherein:

(D) if the first controller determines that the aerosol provision device is not electrically connected to the charging unit then the first controller is arranged to cause the aerosol provision device to enter a fourth mode of operation wherein the aerosol provision device is energized by the first electrical energy storage device in order to commence a first session of use at a time t3;
wherein either the first controller and/or the second controller is arranged to determine that the aerosol provision device is then subsequently electrically connected to the charging unit at a later time t4 during the first session of use and then either: (a) to cause the aerosol provision device to be at least partially energized by the second electrical storage device in order to continue and optionally complete the first session of use; or (b) to cause the aerosol provision device to be energized by the first electrical storage device.

According to another embodiment there is provided an aerosol provision system comprising:
an aerosol provision device comprising a first controller and a first electrical energy storage device;
a charging unit for charging the aerosol provision device, the charging unit comprising a second controller and a second electrical energy storage device;
wherein the first controller and/or the second controller is arranged to determine a connection status between the aerosol provision device and the charging unit and to cause the aerosol provision device to enter into a mode of operation wherein:
wherein according to option (E) if the first controller determines that the aerosol provision device is not electrically connected to the charging unit then the first controller is arranged to cause the aerosol provision device to enter a fifth mode of operation wherein the aerosol provision device is energized by the first electrical energy storage device in order to commence a session of use;
if the first controller and/or second controller determines that the aerosol provision device is electrically connected to the charging unit at a later time during the session of use, the first controller is arranged to control the first electrical energy storage device to continue energizing the aerosol provision device.

According to various embodiments an aerosol provision device may be provided wherein two of options (A), (B), (C), (D) and (E) detailed above are provided.

For example, an aerosol provision device may be provided comprising either options (A) and (B), options (A) and (C), options (A) and (D), options (A) and (E), options (B) and (C), options (B) and (D), options (B) and (E), options (C) and (D) or options (C) and (E).

For example, according to an embodiment there is provided an aerosol provision system comprising:
an aerosol provision device comprising a first controller and a first electrical energy storage device;
a charging unit for charging the aerosol provision device, the charging unit comprising a second controller and a second electrical energy storage device;
wherein the first controller and/or the second controller is arranged to determine a connection status between the aerosol provision device and the charging unit and to cause the aerosol provision device to enter into a mode of operation wherein:

(C) if the first controller and/or second controller determines that the aerosol provision device is electrically connected to the charging unit then the first controller and/or second controller is arranged to cause the aerosol provision device to enter a third mode of operation wherein the aerosol provision device is energized by the second electrical energy storage device in order to commence a first session of use at a time t1;
wherein the first controller is further configured to determine that the aerosol provision device is then subsequently electrically disconnected from the charging unit at a later time t2 during the first session of use and then to cause the aerosol provision device to be energized by the first electrical storage device; and

(D) if the first controller determines that the aerosol provision device is not electrically connected to the charging unit then the first controller is arranged to cause the aerosol provision device to enter a fourth mode of operation wherein the aerosol provision device is energized by the first electrical energy storage device in order to commence a first session of use at a time t3;
wherein either the first controller and/or the second controller is arranged to determine that the aerosol provision device is then subsequently electrically connected to the charging unit at a later time t4 during the first session of use and then either: (a) to cause the aerosol provision device to be at least partially energized by the second electrical storage device in order to continue and optionally complete the first session of use; or (b) to cause the aerosol provision device to be energized by the first electrical storage device.

According to various embodiments an aerosol provision device may be provided wherein three of options (A), (B), (C) (D) and (E) detailed above are provided.

For example, an aerosol provision device may be provided comprising either options (A) and (B) and (C); options (A) and (B) and (D); options (B) and (C) and (D); options (A) and (C) and (D); options (A) and (B) and (E); options (B) and (C) and (E); or options (A) and (C) and (E).

For example, according to an embodiment there is provided an aerosol provision system comprising:
an aerosol provision device comprising a first controller and a first electrical energy storage device;
a charging unit for charging the aerosol provision device, the charging unit comprising a second controller and a second electrical energy storage device;
wherein the first controller and/or the second controller is arranged to determine a connection status between the aerosol provision device and the charging unit and to cause the aerosol provision device to enter into a mode of operation wherein:

(A) if the first controller and/or second controller determines that the aerosol provision device is electrically connected to the charging unit then the first controller and/or second controller is arranged to cause the aerosol provision device to enter a first mode of operation wherein the aerosol provision device is energized by the second electrical energy storage device in order to commence and optionally complete a first session of use; and

(C) if the first controller and/or second controller determines that the aerosol provision device is electrically connected to the charging unit then the first controller and/or second controller is arranged to cause the aerosol provision device to enter a third mode of operation wherein the aerosol provision device is energized by the second electrical energy storage device in order to commence a first session of use at a time t1;
wherein the first controller is further configured to determine that the aerosol provision device is then subsequently electrically disconnected from the charging unit at a later time t2 during the first session of use and then to cause the aerosol provision device to be energized by the first electrical storage device; and

(D) if the first controller determines that the aerosol provision device is not electrically connected to the charging unit then the first controller is arranged to cause the aerosol provision device to enter a fourth mode of operation wherein the aerosol provision device is energized by the first electrical energy storage device in order to commence a first session of use at a time t3;
wherein either the first controller and/or the second controller is arranged to determine that the aerosol provision device is then subsequently electrically connected to the charging unit at a later time t4 during the first session of use and then either: (a) to cause the aerosol provision device to be at least partially energized by the second electrical storage device in order to continue and optionally complete the first session of use; or (b) to cause the aerosol provision device to be energized by the first electrical storage device.

According to various embodiments an aerosol provision device may be provided wherein four of options (A), (B), (C) and (D) detailed above are provided.

For example, an aerosol provision device may be provided comprising options (A) and (B) and (C) and (D), or options (A), (B), (C) and (E)

For example, according to an embodiment there is provided an aerosol provision system comprising:
an aerosol provision device comprising a first controller and a first electrical energy storage device;
a charging unit for charging the aerosol provision device, the charging unit comprising a second controller and a second electrical energy storage device;
wherein the first controller and/or the second controller is arranged to determine a connection status between the aerosol provision device and the charging unit and to cause the aerosol provision device to enter into a mode of operation wherein:

(A) if the first controller and/or second controller determines that the aerosol provision device is electrically connected to the charging unit then the first controller and/or second controller is arranged to cause the aerosol provision device to enter a first mode of operation wherein the aerosol provision device is energized by the second electrical energy storage device in order to commence and optionally complete a first session of use; and

(B) if the first controller determines that the aerosol provision device is not electrically connected to the charging unit then the first controller is arranged to cause the aerosol provision device to enter a second mode of operation wherein the aerosol provision device is energized by the first electrical energy storage device; and

(C) if the first controller and/or second controller determines that the aerosol provision device is electrically connected to the charging unit then the first controller and/or second controller is arranged to cause the aerosol provision device to enter a third mode of operation wherein the aerosol provision device is energized by the second electrical energy storage device in order to commence a first session of use at a time t1;
wherein the first controller is further configured to determine that the aerosol provision device is then subsequently electrically disconnected from the charging unit at a later time t2 during the first session of use and then to cause the aerosol provision device to be energized by the first electrical storage device; and

(D) if the first controller determines that the aerosol provision device is not electrically connected to the charging unit then the first controller is arranged to cause the aerosol provision device to enter a fourth mode of operation wherein the aerosol provision device is energized by the first electrical energy storage device in order to commence a first session of use at a time t3;
wherein either the first controller and/or the second controller is arranged to determine that the aerosol provision device is then subsequently electrically connected to the charging unit at a later time t4 during the first session of use and then either: (a) to cause the aerosol provision device to be at least partially energized by the second electrical storage device in order to continue and optionally complete the first session of use; or (b) to cause the aerosol provision device to be energized by the first electrical storage device.

At the broadest level there is provided an aerosol provision system comprising: an aerosol provision device comprising a first controller and a first electrical energy storage device;
a charging unit for charging the aerosol provision device, the charging unit comprising a second controller and a second electrical energy storage device;
wherein the first controller and/or the second controller is arranged to determine a connection status between the aerosol provision device and the charging unit and to cause the aerosol provision device to enter into a mode of operation wherein:
optionally (A) if the first controller and/or second controller determines that the aerosol provision device is electrically connected to the charging unit then the first controller and/or second controller is arranged to cause the aerosol provision device to enter a first mode of operation wherein the aerosol provision device is energized by the second electrical energy storage device in order to commence and optionally complete a first session of use; and/or
optionally (B) if the first controller determines that the aerosol provision device is not electrically connected to the charging unit then the first controller is arranged to cause the aerosol provision device to enter a second mode of operation wherein the aerosol provision device is energized by the first electrical energy storage device; and/or
optionally (C) if the first controller and/or second controller determines that the aerosol provision device is electrically connected to the charging unit then the first controller and/or second controller is arranged to cause the aerosol provision device to enter a third mode of operation wherein the aerosol provision device is energized by the second electrical energy storage device in order to commence a first session of use at a time t1;
wherein the first controller is further configured to determine that the aerosol provision device is then subsequently electrically disconnected from the charging unit at a later time t2 during the first session of use and then to cause the aerosol provision device to be energized by the first electrical storage device; and/or
optionally (D) if the first controller determines that the aerosol provision device is not electrically connected to the charging unit then the first controller is arranged to cause the aerosol provision device to enter a fourth mode of operation wherein the aerosol provision device is energized by the first electrical energy storage device in order to commence a first session of use at a time t3;
wherein either the first controller and/or the second controller is arranged to determine that the aerosol provision device is then subsequently electrically connected to the charging unit at a later time t4 during the first session of use and then either: (a) to cause the aerosol provision device to be at least partially energized by the second electrical storage device in order to continue and optionally complete the first session of use; or (b) to cause the aerosol provision device to be energized by the first electrical storage device; and/or
optionally (E) if the first controller determines that the aerosol provision device is not electrically connected to the charging unit then the first controller is arranged to cause the aerosol provision device to enter a fifth mode of operation wherein the aerosol provision device is energized by the first electrical energy storage device in order to commence a session of use;
if the first controller and/or second controller determines that the aerosol provision device is electrically connected to the charging unit at a later time during the session of use, the first controller is arranged to control the first electrical energy storage device to continue energizing the aerosol provision device.
It will be understood that option (A) relates to a mode of operation wherein an aerosol provision device is electrically/physically connected to a charging unit, and wherein the aerosol provision device draws power from the battery of the charging unit. For illustrative purposes only, this mode of operation may facilitate e.g. 20 sessions and/or four back-to-back sessions.

Option (B) relates to a mode of operation wherein an aerosol provision device operates independently from the charging unit i.e. the aerosol provision device is not electrically/physically connected to the charging unit. For illustrative purposes only, this mode of operation may facilitate e.g. two sessions and/or two back-to-back sessions.

Option (C) relates to a mode of operation wherein the aerosol provision device is initially electrically/physically connected to a charging unit when a session of use is commenced and wherein the aerosol provision device is then removed from the charging unit mid-session. The session is then completed by the aerosol provision device without interruption.

Option (D) relates to a mode of operation wherein either: (i) the aerosol provision device is operating independently of the charging unit, the aerosol provision device is then inserted into the charging unit mid-session and power to complete the session is then drawn from battery of the charging unit with optionally the timing of a session controlled by the aerosol provision device; or (ii) the aerosol provision device is operating independently of the charging unit, the aerosol provision device is then inserted into the charging unit mid-session and power to complete the session is then drawn from battery of the aerosol provision device (not the charging unit).

With regard to option (D), according to various embodiments a determination may be made that an aerosol provision device is not electrically connected to a charging unit. The aerosol provision device may be energized by the first electrical storage device (i.e. battery) of the aerosol provision device when a first session of use is commenced. However, if during the same first session of use a determination is then made that the aerosol provision device is then electrically connected to the charging unit at a later time t4 during the session of use, the aerosol provision device may then be at least partially energized by the second energy storage device (i.e. battery) of the charging unit. As a result, the battery life of the aerosol provision device may be protected and furthermore when the aerosol provision device is inserted into the charging unit there may be a substantially immediate switching over of power from the battery of the aerosol provision device to the battery of the charging unit. According to various embodiments an essentially seamless transition in battery power management may be achieved when the aerosol provision device is electrically connected mid-session to a charging unit which also preserves the battery life of the aerosol provision device.

Option (E) relates to a mode of operation wherein the aerosol provision device initially operates independently from the charging unit i.e. the aerosol provision device is not electrically/physically connected to the charging unit and the aerosol provision device is subsequently electrically/physically connected to the charging unit mid-session. Despite being connected to the charging unit, the aerosol provision device continues to draw energy from the battery of the aerosol provision device (i.e. operate independently from the charging unit) and not from the battery of the charging unit.

With regard to option (E), according to various embodiments a determination may be made that the aerosol provision device is not electrically connected to the charging unit. The aerosol provision device may be energized by the first electrical energy source when a session of use is commenced. However, if during the same session of use a determination is then made that the aerosol provision device is subsequently electrically connected to the charging unit at a later time during the same session of use, the aerosol provision device may continue to be energized by the first electrical energy source.

According to various embodiment the first and second controllers may be arranged to prioritize the use of the relatively larger electrical storage device of the charging unit. As a result, the lifetime of the electrical storage device of the aerosol provision device can be extended i.e. the total number of cycles of the first electrical storage device can be kept to a minimum.

According to various embodiments the first controller and the second controller may operate in a master/slave relationship. According to various embodiments, the controller of the charging unit may operate as a master controller and the controller of the aerosol provision device may operate as a slave controller. The controllers (in particular the controller of the charging unit) may be arranged to prioritize use of the battery of the charging unit wherever possible in order to energize the aerosol provision device. According to various embodiments the battery of the charging unit may have a larger maximum capacity than the maximum capacity of the battery of the aerosol provision device. The battery of the charging unit may comprise a lithium cobalt oxide (LiCoO₂) battery, a lithium manganese oxide (LiMn₂O₄) battery, a lithium nickel manganese cobalt oxide (LiNiₓMn_{y}CO_{z}O₂) battery or a lithium nickel cobalt aluminum oxide (LiNiCoAlO₂) battery. The battery of the aerosol provision device may comprise a lithium iron phosphate (LiFePO₄) battery or a lithium titanate or lithium titanium oxide (LTO) battery. The battery of the aerosol provision device may have a capacity ≤ 200 mAh whereas the battery of the charging unit may have a capacity ≥ 1000 mAh. Accordingly, the battery of the charging unit may have a capacity which is at least five times that of the battery of the aerosol provision device. Furthermore, it may only be possible to recharge the battery of the aerosol provision device a relatively low number of times before performance of the battery begins to deteriorate. It may therefore be desirable to limit the number of times that the battery of the aerosol provision device is recharged. According to various embodiments by following the approach discussed above the lifetime of battery of the aerosol provision device can be extended as long as possible e.g. the total number of cycles of recharging that the battery of the aerosol provision device experiences can be kept to a minimum in order to prolong the performance of the aerosol provision device.

The first controller may comprise a first microcontroller or a first microprocessor. The second controller may comprise a second microcontroller or a second microprocessor.

Optionally, according to option (C) the system further comprises a notification unit configured to provide a notification to a user in response to the first electrical energy storage device having insufficient energy to complete the first session of use. Optionally, the notification is a haptic notification.

Optionally, according to option (D) the first controller is further arranged: (i) to determine that the aerosol provision device is then subsequently electrically disconnected from the charging unit at a later time t5 during the first session of use; and (ii) to cause the aerosol provision device to be energized by the first electrical storage device.

Optionally, either the first controller and/or the second controller is arranged: (i) to determine that the aerosol provision device is then subsequently electrically connected to the charging unit at a later time t6 during the first session of use; and (ii) to cause the aerosol provision device to be at least partially energized by the second electrical storage device in order to continue the first session of use.

Optionally, t6 > t5 > t4 > t3. In other words, time t6 is subsequent to time t5, time t5 is subsequent to time t4, and time t4 is subsequent to time t3.

Optionally, according to option (D) either the first controller and/or the second controller is further arranged: (i) to determine that the first session of use has been completed; (ii) to determine that the aerosol provision device is electrically connected to the charging unit; (iii) optionally to determine that it is desired to perform a second session of use; and (iv) to determine if the first electrical energy storage device and/or the second electrical energy storage device comprises sufficient electrical energy in order to energize the aerosol provision device in order to commence and optionally complete a second session of use.

Optionally, according to option (D) the first controller is further arranged: (i) to determine that the first session of use has been completed; (ii) to determine that the aerosol provision device is electrically disconnected from the charging unit; (iii) optionally to determine that it is desired to perform a second session of use; and (iv) to determine if the first electrical energy storage device comprises sufficient electrical energy in order to energize the aerosol provision device in order to commence and optionally complete a second session of use.

Optionally, according to option (C) and/or option (E) the when the first electrical energy storage device energizes the aerosol provision device and the aerosol provision device is electrically connected to the charging unit, the first controller or the second controller is configured to terminate the session of use when the charge level of the first electrical energy device storage reaches a shutdown threshold. Optionally, the first electrical energy storage device has sufficient energy at the shutdown threshold to permit the first controller to perform charging communications with the charging unit.

Optionally, according to option (C) and/or option (E) when the first electrical energy storage device energizes the aerosol provision device and the aerosol provision device is connected to the charging unit, the first controller or the second controller is configured to control the second electrical energy storage device to energize the aerosol provision device when the charge level of the first electrical energy storage device reaches a shutdown threshold.

Optionally according to option (C) and/or option (E) the first controller or the second controller is configured to determine a charge level of the second electrical energy storage device in response to a further session of use being commenced.

Optionally, in response to the second electrical energy storage device having a charge level above a threshold, the first controller or the second controller is configured to control the second electrical energy storage device to energize the aerosol provision device in the further session of use

Optionally, in response to the second electrical energy storage device having a charge level below the threshold, the first controller or the second controller is configured to control the first electrical energy storage device to energize the aerosol provision device in the further session of use.

In embodiments according to option (C) and/or option (E), a notification unit is provided that is configured to, in response to: a later session of use being commenced while the aerosol provision device is connected to the charging unit; and the first energy storage having insufficient energy to complete the aerosol generating session, provide a notification to a user.

Optionally, the first electrical energy storage device comprises either: (i) a lithium iron phosphate (LiFePO₄) battery; or (ii) a lithium titanate or lithium titanium oxide (LTO) battery.

Optionally, the first electrical energy storage device has a capacity in the range: (i) < 50 mAh; (ii) 50-100 mAh; (iii) 100-150 mAh; or (iv) 150-200 mAh.

Optionally, the second electrical energy storage device comprises: (i) a lithium cobalt oxide (LiCoO₂) battery; (ii) a lithium manganese oxide (LiMn₂O₄) battery; (iii) a lithium nickel manganese cobalt oxide (LiNiₓMn_{y}CO_{z}O₂) battery; or (iv) a lithium nickel cobalt aluminum oxide (LiNiCoAlO₂) battery.

Optionally, the second electrical energy storage device has a capacity in the range: (i) 1000-1100 mAh; (ii) 1100-1200 mAh; (iii) 1100-1200 mAh; (iv) 1200-1300 mAh; (v) 1300-1400 mAh; (vi) 1400-1500 mAh; (vii) 1500-2000 mAh; or (viii) > 2000 mAh.

Optionally, the first electrical energy storage device has a capacity C₁ and the second electrical energy storage device has a capacity C₂ and wherein the ratio C₂/C₁ is in the range: (i) < 2; (ii) 2-3; (iii) 3-4; (iv) 4-5; (v) 5-6; (vi) 6-7; (vii) 7-8; (viii) 8-9; (ix) 9-10; (x) 10-11; (xi) 11-12; (xii) 12-13; (xiii) 13-14; (xiv) 14-15; (xv) 15-20; or (xvi) > 20.

According to an aspect there is provided a method of operating an aerosol provision system comprising:
providing an aerosol provision device comprising a first controller and a first electrical energy storage device;
providing a charging unit for charging the aerosol provision device, the charging unit comprising a second controller and a second electrical energy storage device;
arranging for the first controller and/or the second controller to determine a connection status between the aerosol provision device and the charging unit and to cause the aerosol provision device to enter into a mode of operation wherein either option (A) and/or option (B) and/or option (C) and/or option (D) and/or option (E) below apply:

According to another aspect there is provided an aerosol provision device comprising a first controller and a first electrical energy storage device wherein the aerosol provision device is connectable, in use, to a charging unit for charging the aerosol provision device, the charging unit comprising a second controller and a second electrical energy storage device;
wherein the first controller and/or the second controller is arranged to determine a connection status between the aerosol provision device and the charging unit and to cause the aerosol provision device to enter into a mode of operation wherein either option (A) and/or option (B) and/or option (C) and/or option (D) and/or option (E) below apply:
wherein according to option (A) if the first controller and/or second controller determines that the aerosol provision device is electrically connected to the charging unit then the first controller and/or second controller is arranged to cause the aerosol provision device to enter a first mode of operation wherein the aerosol provision device is energized by the second electrical energy storage device in order to commence and optionally complete a first session of use;
wherein according to option (B) if the first controller determines that the aerosol provision device is not electrically connected to the charging unit then the first controller is arranged to cause the aerosol provision device to enter a second mode of operation wherein the aerosol provision device is energized by the first electrical energy storage device;
wherein according to option (C) if the first controller and/or second controller determines that the aerosol provision device is electrically connected to the charging unit then the first controller and/or second controller is arranged to cause the aerosol provision device to enter a third mode of operation wherein the aerosol provision device is energized by the second electrical energy storage device in order to commence a first session of use at a time t1;
wherein the first controller is further configured to determine that the aerosol provision device is then subsequently electrically disconnected from the charging unit at a later time t2 during the first session of use and then to cause the aerosol provision device to be energized by the first electrical storage device;
wherein according to option (D) if the first controller determines that the aerosol provision device is not electrically connected to the charging unit then the first controller is arranged to cause the aerosol provision device to enter a fourth mode of operation wherein the aerosol provision device is energized by the first electrical energy storage device in order to commence a first session of use at a time t3;
wherein either the first controller and/or the second controller is arranged to determine that the aerosol provision device is then subsequently electrically connected to the charging unit at a later time t4 during the first session of use and then either: (a) to cause the aerosol provision device to be at least partially energized by the second electrical storage device in order to continue and optionally complete the first session of use; or (b) to cause the aerosol provision device to be energized by the first electrical storage device;
wherein according to option (E) if the first controller determines that the aerosol provision device is not electrically connected to the charging unit then the first controller is arranged to cause the aerosol provision device to enter a fifth mode of operation wherein the aerosol provision device is energized by the first electrical energy storage device in order to commence a session of use;
if the first controller and/or second controller determines that the aerosol provision device is electrically connected to the charging unit at a later time during the session of use, the first controller is arranged to control the first electrical energy storage device to continue energizing the aerosol provision device.

According to another aspect there is provided a charging unit comprising a second controller and a second electrical energy storage device wherein the charging unit is connectable, in use, to an aerosol provision device for charging the aerosol provision device, the aerosol provision device comprising a first controller and a first electrical energy storage device;
wherein the first controller and/or the second controller is arranged to determine a connection status between the aerosol provision device and the charging unit and to cause the aerosol provision device to enter into a mode of operation wherein either option (A) and/or option (B) and/or option (C) and/or option (D) and/or option (E) below apply:
wherein according to option (A) if the first controller and/or second controller determines that the aerosol provision device is electrically connected to the charging unit then the first controller and/or second controller is arranged to cause the aerosol provision device to enter a first mode of operation wherein the aerosol provision device is energized by the second electrical energy storage device in order to commence and optionally complete a first session of use;
wherein according to option (B) if the first controller and/or the second controller determines that the aerosol provision device is not electrically connected to the charging unit then the first controller is arranged to cause the aerosol provision device to enter a second mode of operation wherein the aerosol provision device is energized by the first electrical energy storage device;
wherein according to option (C) if the first controller and/or second controller determines that the aerosol provision device is electrically connected to the charging unit then the first controller and/or second controller is arranged to cause the aerosol provision device to enter a third mode of operation wherein the aerosol provision device is energized by the second electrical energy storage device in order to commence a first session of use at a time t1;
wherein the first controller is further configured to determine that the aerosol provision device is then subsequently electrically disconnected from the charging unit at a later time t2 during the first session of use and then to cause the aerosol provision device to be energized by the first electrical storage device;
wherein according to option (D) if the first controller and/or the second controller determines that the aerosol provision device is not electrically connected to the charging unit then the first controller is arranged to cause the aerosol provision device to enter a fourth mode of operation wherein the aerosol provision device is energized by the first electrical energy storage device in order to commence a first session of use at a time t3;
wherein either the first controller and/or the second controller is arranged to determine that the aerosol provision device is then subsequently electrically connected to the charging unit at a later time t4 during the first session of use and then either: (a) to cause the aerosol provision device to be at least partially energized by the second electrical storage device in order to continue and optionally complete the first session of use; or (b) to cause the aerosol provision device to be energized by the first electrical storage device;
wherein according to option (E) if the first controller determines that the aerosol provision device is not electrically connected to the charging unit then the first controller is arranged to cause the aerosol provision device to enter a fifth mode of operation wherein the aerosol provision device is energized by the first electrical energy storage device in order to commence a session of use;
if the first controller and/or second controller determines that the aerosol provision device is electrically connected to the charging unit at a later time during the session of use, the first controller is arranged to control the first electrical energy storage device to continue energizing the aerosol provision device.

### BRIEF DESCRIPTION OF THE DRAWINGS

Various embodiments will now be described, by way of example only, and with reference to the accompanying drawings, in which:

FIG. 1 shows an aerosol provision system comprising an aerosol provision device located within a charging unit;

FIG. 2 shows a flow chart illustrating various modes of operation of an aerosol provision device according to various embodiments; and

FIG. 3 shows a flow chart illustrating various modes of operation of a charging unit according to various embodiments.

### DETAILED DESCRIPTION

According to the present disclosure, a “non-combustible” aerosol provision system is one where a constituent aerosol generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol generating material is not a requirement.

In some embodiments, the non-combustible aerosol provision system is an aerosol generating material heating system, also known as a heat-not-burn system. An example of such a system is a tobacco heating system.

In some embodiments, the non-combustible aerosol provision system is a hybrid system to generate aerosol using a combination of aerosol generating materials, one or a plurality of which may be heated. Each of the aerosol generating materials may be, for example, in the form of a solid, liquid or gel and may or may not contain nicotine. In some embodiments, the hybrid system comprises a liquid or gel aerosol generating material and a solid aerosol generating material. The solid aerosol generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol generating material, an aerosol generating material storage area, an aerosol generating material transfer component, an aerosol generator, an aerosol generation area, a housing, a wrapper, a filter, a mouthpiece, and/or an aerosol-modifying agent.

Aerosol generating material is a material that is capable of generating aerosol, for example when heated, irradiated or energized in any other way. Aerosol generating material may, for example, be in the form of a solid, liquid or semi-solid (such as a gel) which may or may not contain an active substance and/or flavorants.

The aerosol generating material may comprise a binder and an aerosol former. Optionally, an active and/or filler may also be present. Optionally, a solvent, such as water, is also present and one or more other components of the aerosol generating material may or may not be soluble in the solvent. In some embodiments, the aerosol generating material is substantially free from botanical material. In particular, in some embodiments, the aerosol generating material is substantially tobacco free.

The aerosol generating material may comprise or be an aerosol generating film. The aerosol generating film may be formed by combining a binder, such as a gelling agent, with a solvent, such as water, an aerosol-former and one or more other components, such as active substances, to form a slurry and then heating the slurry to volatilize at least some of the solvent to form the aerosol generating film. The slurry may be heated to remove at least about 60 wt%, 70 wt%, 80 wt%, 85 wt% or 90 wt% of the solvent. The aerosol generating film may be a continuous film or a discontinuous film, such an arrangement of discrete portions of film on a support. The aerosol generating film may be substantially tobacco free.

The aerosol generating film may comprise or be a sheet, which may optionally be shredded to form a shredded sheet.

The aerosol generating material may comprise one or more active substances and/or flavors, one or more aerosol-former materials, and optionally one or more other functional material.

An aerosol generator is an apparatus configured to cause aerosol to be generated from the aerosol generating material. In some embodiments, the aerosol generator is a heater configured to subject the aerosol generating material to heat energy, so as to release one or more volatiles from the aerosol generating material to form an aerosol. In some embodiments, the aerosol generator is configured to cause an aerosol to be generated from the aerosol generating material without heating. For example, the aerosol generator may be configured to subject the aerosol generating material to one or more of vibration, increased pressure, or electrostatic energy.

A consumable is an article comprising or consisting of aerosol generating material, part or all of which is intended to be consumed during use by a user. A consumable may comprise one or more other components, such as an aerosol generating material storage area, an aerosol generating material transfer component, an aerosol generation area, a housing, a wrapper, a mouthpiece, a filter and/or an aerosol-modifying agent. A consumable may also comprise an aerosol generator, such as a heater, that emits heat to cause the aerosol generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

Induction heating is a process in which an electrically-conductive object, referred to as a susceptor, is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents and when such eddy currents are generated in the object, their flow against the electrical resistance of the object causes the object to be heated. This process is called Joule, ohmic or resistive heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

Various embodiments will now be described in more detail.

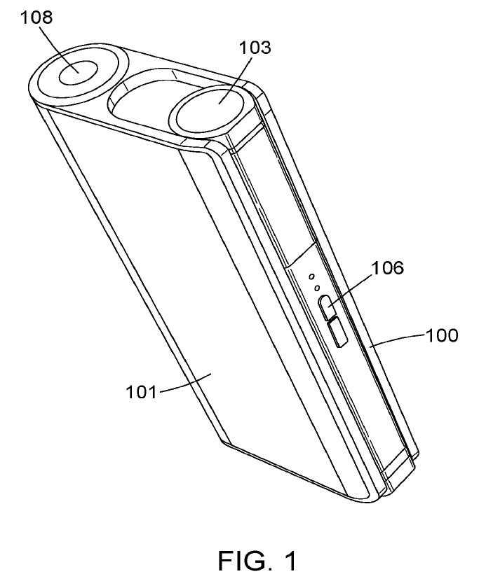

FIG. 1 shows an aerosol provision system comprising an aerosol provision device 100 which is shown inserted within a cavity of a charging unit 101. The aerosol provision device 100 is arranged to generate aerosol from an aerosol generating article or consumable (not shown) which may be inserted, in use, into the aerosol provision device 100.

The aerosol provision device 100 may comprise an elongate structure which extends along a longitudinal axis. The aerosol provision device 100 has a proximal end, which is closest to the user (e.g. the user’s mouth) when in use by the user to inhale the aerosol generated by the aerosol provision device 100. The aerosol provision device 100 further comprises a distal end which will be furthest from the user when in use. The proximal end may also be referred to as the mouth end. The aerosol provision device 100 also accordingly defines a proximal direction which is directed towards the user when in use i.e. in the direction from the distal end to the proximal end. Further, the aerosol provision device 100 also likewise defines a distal direction which is directed away from the user when in use i.e. in the direction from the proximal end to the distal end.

The aerosol provision device 100 may be removably inserted into the charging unit 101 in order to be charged. The charging unit 101 comprises a cavity for receiving the aerosol provision device 100. The aerosol provision device 100 may be inserted into the cavity via an opening. The cavity may also comprise a longitudinal opening. A portion of the aerosol provision device 100 may comprise a first side. One or more user-operable control elements such as buttons 106 which can be used to operate the aerosol provision device 100 may be provided on the first side of the aerosol provision device 100. The first side of the aerosol provision device 100 may be received within the longitudinal opening provided in the charging unit 101.

The cavity of the charging unit 101 may have a cross-sectional profile which only permits the aerosol provision device 100 to be inserted into the charging unit 101 in a single particular orientation. The outer profile of the aerosol provision device 100 may comprise an arcuate portion and a linear portion. The cross-sectional profile of the cavity provided in the charging unit 101 may also comprise a similar arcuate portion and a linear portion. The linear portion of the cross-sectional profile of the cavity may correspond with the longitudinal opening.

The aerosol provision device 100 comprises an opening leading into a heating chamber. A rod shaped aerosol generating article comprising aerosol generating material may be inserted through the opening and may be retained within the heating chamber of the aerosol provision device 100. The aerosol generating article may be heated by a heating element so that an aerosol or other inhalable medium may be generated which may then be inhaled by a user of the aerosol provision device 100.

The charging unit 101 may include a slidable lid 103. When the aerosol provision device 100 is inserted into the charging unit 101 in order to be recharged, the slidable lid 103 may be closed so as to cover the opening into the aerosol provision device 100. The charging unit 101 may include a user interface such as display 108.

The charging unit 101 comprises a controller (not shown) which is configured to control various aspects of the charging unit 101. In particular, the controller located within the charging unit 101 may be arranged to control an electrical energy storage device of the charging unit 101. The electrical energy storage device may comprise, for example, a battery. The controller located within charging unit 101 may comprise a central processing unit (CPU), a microprocessor or a microcontroller (MCU).

The battery of the charging unit 101 may comprise a lithium cobalt oxide (LiCoO₂) battery, a lithium manganese oxide (LiMn₂O₄) battery, a lithium nickel manganese cobalt oxide (LiNiₓMn_{y}CO_{z}O₂) battery or a lithium nickel cobalt aluminum oxide (LiNiCoAlO₂) battery. The battery may have a capacity ≥ 1000 mAh.

The aerosol provision device 100 may also comprise a controller (not shown) which is configured to control various aspects of the aerosol provision device 100. In particular, the controller located within the aerosol provision device 100 may be configured to control an electrical energy source of the aerosol provision device 100. The controller may comprise a central processing unit (CPU), a microprocessor or a microcontroller (MCU). The electrical energy storage device may comprise a battery. For example, the battery of the aerosol provision device 100 may comprise a lithium iron phosphate (LiFePO₄) battery or a lithium titanate or lithium titanium oxide (LTO) battery. The battery may have a capacity ≤ 200 mAh.

The respective controllers of the charging unit 101 and aerosol provision device 100 may be arranged to communicate with each other when the aerosol provision device 100 is electrically connected to the charging unit 101 i.e. when the aerosol provision device is 100 inserted into or docked within the charging unit 101.

It is also contemplated that the respective controllers may be arranged so as to communicate wirelessly with each other when the aerosol provision device 100 is remote from the charging unit 101. Wireless communication can be enabled by wireless fidelity (WiFi), Bluetooth, any other suitable wireless local area network (WLAN), wireless personal area network (WPAN) or wireless sensor actor network (WSAN) protocols.

In the situation where the aerosol provision device 100 is inserted and secured into the charging unit 101 so that an electrical connection is made between the aerosol provision device 100 and the charging unit 101, then the controller of the charging unit 101 (which may be referred to hereinafter as the “second” controller) may be arranged so as to operate as a master controller. By way of contrast, the controller of the aerosol provision device 100 (which may be referred to hereinafter as the “first” controller) may be arranged so as to operate as a slave controller. According to such an embodiment, various determinations which could potentially be made by either the first controller or the second controller, may be preferentially made by the second controller acting as a master controller. For example, according to an embodiment a mode of operation involving supplying electrical energy from the battery of the charging unit 101 to the battery of the aerosol provision device 100 may occur after a determination is made that the aerosol provision device 100 has been inserted into the charging unit 101 during a session of use. According to an embodiment, the determination may be made by the second controller acting as a master controller.

However, other embodiments are also contemplated wherein a determination may be made that the aerosol provision device 100 has been inserted into the charging unit 101 during a session of use by the first controller located in the aerosol provision device 100. Further embodiments are contemplated wherein, for example, a determination may be made initially by the second controller, and the determination may then be confirmed or checked by the first controller (or vice versa).

According to an embodiment when a user starts a session, electrical energy may be provided from the battery of the charging unit 101 in order to heat one or more heating elements located within the aerosol provision device 100 so that an aerosol or other inhalable medium may be generated which may then be inhaled by a user of the aerosol provision device 100.

In the situation when the aerosol provision device 100 is remote or separated from the charging unit 101, each of the respective controllers of the aerosol provision device 100 and the charging unit 101 may operate as a master controller. In this situation, if a session is started by the user, the battery of the aerosol provision device provides energy to heat the heating element so that an aerosol or other inhalable medium may be generated which may then be inhaled by a user of the aerosol provision device 100.

It will be understood that the charging unit 101 and the aerosol provision device 100 can enter into and out of a master/slave relationship whenever the aerosol provision device is inserted into, or removed from the charging unit 101.

Details of modes of operation of the aerosol provision device 100 and the charging unit 101 in use are described in more detail herein.

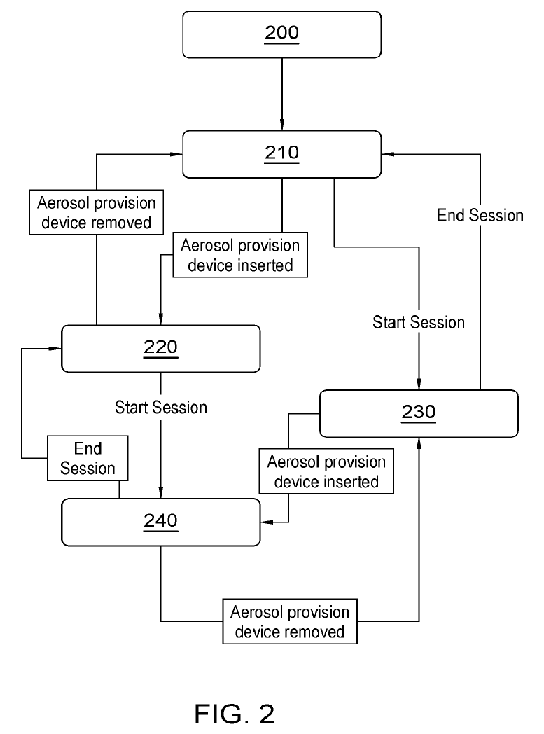

FIG. 2 shows a flow chart illustrating modes of operation of an aerosol provision device 100 according to various embodiments. In particular, FIG. 2 illustrates aspects of the controller logic as used by the controller of the aerosol provision device 100.

The controller of the aerosol provision device 100 may operate initially in an idle state 200 until an operation command is received by the controller of the aerosol provision device 100. The operation command may occur when a user activates one or more of the buttons 106 of the aerosol provision device 100 to e.g. start a session of use.

Once an operation command is received by the controller of the aerosol provision device 100, the controller enters a first state 210 corresponding to a situation wherein the aerosol provision device 100 is not inserted into the charging unit 101 and no session has yet commenced. In the first state 210 (i.e. wherein the aerosol provision device 100 is not inserted into the charging unit 101 and no session has yet commenced), the controller of the aerosol provision device 100 initially monitors the battery level of the aerosol provision device 100 in order to check the voltage and/or power level of the battery of the aerosol provision device 100 in order to determine if the battery is sufficiently charged to start (but not necessarily complete) a session which may be initiated by the user.

The battery of the aerosol provision device 100 may be deemed sufficiently charged if it satisfies an acceptance threshold criterion. According to various embodiments the battery of the aerosol provision device 100 may comprise either a lithium iron phosphate (LiFePO₄) battery or a lithium titanate or lithium titanium oxide (LTO) battery. The battery of the aerosol provision device 100 may have a capacity when full charged in the range: (i) < 50 mAh; (ii) 50-100 mAh; (iii) 100-150 mAh; or (iv) 150-200 mAh. According to various embodiments, the battery of the aerosol provision device 100 may be deemed to be sufficiently charged in order to at least commence a session of use if the determined current capacity of the battery exceeds a threshold which is within a range: (i) < 20 mAh; (ii) 20-40 mAh; (iii) 40-60 mAh; (iv) 60-80 mAh; (v) 80-100 mAh; (vi) 100-120 mAh; (vii) 120-140 mAh; (viii) 140-160 mAh; (ix) 160-180 mAh; or (x) 180-200 mAh.

Once a session has been initiated by the user, if it is determined that the battery of the aerosol provision device 100 is sufficiently charged and the aerosol provision device 100 is not inserted into the charging unit 101, then the controller of the aerosol provision device 100 enters a third state 230 corresponding to a situation wherein the aerosol provision device 100 is not inserted into the charging unit 101 but a session has nonetheless been commenced. If the aerosol provision device 101 is already inserted into the charging unit 101 or if the aerosol provision device 100 is inserted into the charging unit 101 whilst the controller is in the first state 210 (i.e. wherein the aerosol provision device 100 is not inserted into the charging unit 101 and no session has yet been commenced), then the controller of the aerosol provision device 100 may enter into a second state 220 corresponding to a situation wherein the aerosol provision device 100 is inserted into the charging unit 101 but no session has yet been commenced.

In the third state 230 (i.e. wherein the aerosol provision device 100 is not inserted into the charging unit 101 but a session has nonetheless been commenced), the battery of the aerosol provision device 100 provides energy to heat the heating element so that an aerosol or other inhalable medium may be generated which may then be inhaled by a user of the aerosol provision device 100. In the third state 230 (i.e. wherein the aerosol provision device 100 is not inserted into the charging unit 101 but a session has nonetheless been commenced), the controller of the aerosol provision device 100 may log the battery level or current battery capacity of the aerosol provision device 100.

Once the session has ended (e.g. the session cycle has ended, the user ends it, or the battery level is no longer sufficient), the controller may return to the first state 210 (i.e. wherein the aerosol provision device 100 is not inserted into the charging unit 101 and no session has yet been commenced). If the aerosol provision device 100 was inserted into the charging unit 101 after a session had commenced, then the controller may enter a fourth state 240 corresponding to a situation wherein the aerosol provision device 100 is inserted into the charging unit 101 and a session of use is commenced.

In the second state 220 (i.e. wherein the aerosol provision device 100 is inserted into the charging unit 101 but no session has yet been commenced), either the controller of the aerosol provision device 100 and/or the controller of the charging unit 101 may check the battery level of the aerosol provision device 100 and/or the charging unit 101 in order to determine if the battery of the aerosol provision device 100 and/or the battery of the charging unit 101 is sufficiently charged in order to support a session of use. If it is determined that the battery of the aerosol provision device 100 and/or the battery of the charging unit 101 is sufficiently charged in order to support a session of use then the controller of the aerosol provision device 100 may return to the fourth state 240 (i.e. wherein the aerosol provision device 100 is inserted into the charging unit 101 and a session of use is commenced).

If the aerosol provision device 100 is removed from the charging unit 101 whilst in the second state 220 (i.e. wherein the aerosol provision device 100 is inserted into the charging unit 101 but no session has yet been commenced), then the controller of the aerosol provision device 100 may enter the first state 210 (i.e. wherein the aerosol provision device 100 is not inserted into the charging unit 101 and no session has yet been commenced).

The controller of the aerosol provision device 100 may be arranged to remain in the fourth state 240 (i.e. wherein the aerosol provision device 100 is inserted into the charging unit 101 and a session of use is commenced) whilst a session is taking place. When the controller of the aerosol provision device 100 is in the fourth state 240 then the aerosol provision device 100 is located within the charging unit 100, the aerosol provision device 100 is electrically connected to the charging unit 100 and a session of use is being performed. When the controller of the aerosol provision device 100 is in the fourth state 240 then the controller of the aerosol provision device 100 may be arranged to log regularly the battery level or current capacity of the battery of the aerosol provision device 100. In the fourth state 240 (i.e. wherein the aerosol provision device 100 is inserted into the charging unit 101 and a session of use is commenced), the battery of the charging unit 101 may be used to provide energy to heat the heating element so that an aerosol or other inhalable medium may be generated which may then be inhaled by a user of the aerosol provision device 100.

When the controller of the aerosol provision device 100 is in the fourth state 240 (i.e. wherein the aerosol provision device 100 is inserted into the charging unit 101 and a session of use is commenced) and the session then ends (e.g. the session cycle has ended, the user ends the session or the battery level of either the aerosol provision device 100 and/or the charging unit 101 is no longer sufficient to continue performing a session of use) and the aerosol provision device 100 is not removed from the charging unit 101, then the controller of the aerosol provision device 100 may be arranged to enter the second state 220 (i.e. wherein the aerosol provision device 100 is inserted into the charging unit 101 but no session of use is being performed). When in the second state 220 (i.e. wherein the aerosol provision device 100 is inserted into the charging unit 101 but no session is being performed), if the aerosol provision device 100 is then removed from the charging unit 101, the controller of the aerosol provision device 100 may then be arranged to enter the first state 210 (i.e. wherein the aerosol provision device 100 is not inserted into the charging unit 101 and wherein no session is being performed).

According to various embodiments when the controller of the aerosol provision device 100 is in the fourth state 240 and the aerosol provision device 100 is removed from the charging unit 101 mid-session by the user, the controller of the aerosol provision device 100 may then be arranged to enter the third state 230 (i.e. wherein the aerosol provision device 100 is not inserted into the charging unit 101 but a session has nonetheless been commenced) and the session of use may be arranged to continue.

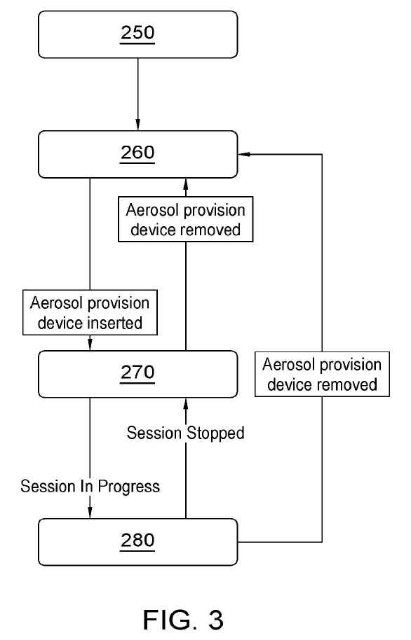

FIG. 3 shows a flow diagram illustrating various modes of operation of a controller of a charging unit 101 in accordance with various embodiments. More specifically, the flow diagram shown in FIG. 3 shows controller logic for the charging unit 101.

The controller of the charging unit 101 may commence in a fifth (idle) state 250 until an operation command is received by the controller of the aerosol provision device 100 and/or the charging unit 101. The operation command can be when, for example, a charging cable is inserted into the charging unit 101 or when a user activates one or more of the buttons 106 of the aerosol provision device 106 or a button on the charging unit 101.

Once an operation command is received by the controller of the charging unit 101, the controller of the charging unit 101 may be arranged to enter a sixth state 260 which corresponds with a situation wherein the aerosol provision device 100 is not inserted into the charging unit 101 and wherein no session of use has been commenced. In the sixth state 260 (i.e. wherein the aerosol provision device 100 is not inserted into the charging unit 101 and wherein no session of use has been commenced), the controller of the charging unit 101 may be arranged to check the battery level or the current capacity of the battery of the charging unit 101 and whether or not a charging cable (e.g. a USB cable) that may be connected to an external power source has been inserted into the charging unit 101.

If a charging cable has been inserted into the charging unit 101 whilst the controller of the charging unit 101 is in the sixth state 260 (i.e. the charging unit 101 is not electrically connected to the aerosol provision device 100 and wherein no session has been commenced) then the battery of the charging unit 101 may be arranged to be charged by the external power supply. If upon receiving the operation command the aerosol provision device 100 has either already been inserted into the charging unit 101 or if the aerosol provision device 100 is subsequently inserted into the charging unit 101 whilst the controller of the charging unit 101 is in the sixth state 260 (i.e. wherein the aerosol provision device 100 is not inserted into the charging unit 101 and wherein no session of use has been commenced), then the controller of the charging unit 101 may be arranged to enter a seventh state 270 (i.e. wherein the aerosol provision device 100 is inserted into the charging unit 101 but wherein no session of use has yet been commenced). According to various embodiments the seventh state 270 relates to a situation wherein the aerosol provision device 100 is inserted into the charging unit 101 and is electrically connected to the charging unit 101, but wherein no session of use has yet been commenced.

In the seventh state 270 (i.e. wherein the aerosol provision device 100 is inserted into the charging unit 101 but wherein no session of use has yet been commenced) the controller of the charging unit 101 may be arranged to check again if the aerosol provision device 100 is still connected to the charging unit 101. If it is determined that the aerosol provision device 100 has been removed from the charging unit 101 or if it is determined that the aerosol provision device 100 is subsequently removed from the charging unit 101 whilst in the seventh state 270 (i.e. wherein the aerosol provision device 100 is inserted into the charging unit 101 but wherein no session of use has yet been commenced), then the controller of the charging unit 101 may revert back into the sixth state 260 (i.e. the charging unit 101 is not electrically connected to the aerosol provision device and wherein no session has been commenced).

In the seventh state 270 (i.e. wherein the aerosol provision device 100 is inserted into the charging unit 101 but wherein no session of use has yet been commenced) when the aerosol provision device 100 is connected to the charging unit 101, the controller of the charging unit 101 may be arranged to check the battery energy or current capacity of the battery in the charging unit 101 and/or the battery in the aerosol provision device 100. With the charging cable plugged in, if it is determined that the battery in the aerosol provision device 100 is below an acceptable threshold criterion, then the battery of the aerosol provision device 100 may be recharged via the charging cable. For example, the battery of the aerosol provision device 100 may have a capacity when fully charged in the range: (i) < 50 mAh; (ii) 50-100 mAh; (iii) 100-150 mAh; or (iv) 150-200 mAh. According to various embodiments, the battery of the aerosol provision device 100 may be deemed to be below an acceptable threshold criterion and hence to need recharging if the determined current capacity of the battery is determined to be within a range: (i) < 20 mAh; (ii) 20-40 mAh; (iii) 40-60 mAh; (iv) 60-80 mAh; (v) 80-100 mAh; (vi) 100-120 mAh; (vii) 120-140 mAh; (viii) 140-160 mAh; (ix) 160-180 mAh; or (x) 180-200 mAh.

In the situation wherein it is determined that the battery of the charging unit 101 is also below an acceptable threshold, then the battery of the charging unit 101 may also be recharged via the charging cable. The battery of the charging unit 101 may be charged simultaneously with the battery of the aerosol provision device 100. According to various embodiments electrical power from an external power source may be supplied in a pulsed manner to either the battery of the aerosol provision device 100 and/or the battery of the charging unit 100. According to an embodiment charging pulses may be supplied alternately between the aerosol provision device 100 and the charging unit 101 so that any specific point in time either the battery of the aerosol provision device 100 is being charged by the external power supply or alternatively the battery of the charging unit 101 is being charged by the external power supply so that the batteries of the aerosol provision device 100 and the charging unit 101 are not charged simultaneously. Embodiments are contemplated wherein the battery of the aerosol provision device 100 may be fully recharged before the battery of the charging unit 101 is fully recharged due to the battery of the aerosol provision device 100 having a lower capacity than that of the charging unit 101.

According to various embodiments the battery (or more generally the electrical energy storage device) of the charging unit 101 may comprise: (i) a lithium cobalt oxide (LiCoO₂) battery; (ii) a lithium manganese oxide (LiMn₂O₄) battery; (iii) a lithium nickel manganese cobalt oxide (LiNiₓMn_{y}CO_{z}O₂) battery; or (iv) a lithium nickel cobalt aluminum oxide (LiNiCoAlO₂) battery. According to various embodiments the battery of the charging unit 101 may be recharged by an external power supply if the determined capacity of the battery of the charging unit 101 is determined to be below a threshold, wherein the threshold is in the range: (i) 1000-1100 mAh; (ii) 1100-1200 mAh; (iii) 1100-1200 mAh; (iv) 1200-1300 mAh; (v) 1300-1400 mAh; (vi) 1400-1500 mAh; (vii) 1500-2000 mAh; or (viii) > 2000 mAh.

According to various embodiments the battery of the aerosol provision device 100 and the battery of the charging unit 101 may be charged individually, simultaneously, synchronously or asynchronously optionally via a charging cable or a wireless charging interface when in the seventh state 270 (i.e. wherein the aerosol provision device 100 is inserted into the charging unit 101 but wherein no session of use has yet been commenced).

When in the seventh state 270 (i.e. wherein the aerosol provision device 100 is inserted into the charging unit 101 but wherein no session of use has yet been commenced) and it is determined by the controller of the charging unit 101 that no charging cable has been inserted into the charging unit 101 (or no wireless charging interface has been activated) and if it is determined that the power level or current capacity of the battery of the aerosol provision device 100 is below an acceptable threshold criterion, then the battery of the aerosol provision device 100 may be charged via the battery of the charging unit 101.

When a session of use is started or by the user (or otherwise commenced) and the controller of the charging unit 101 is in the seventh state 270 (i.e. wherein the aerosol provision device 100 is inserted into the charging unit 101 but wherein no session of use has yet been commenced), any charging of the battery of the aerosol provision device 100 and/or the battery of the charging unit 101 that may have been initiated whilst in the seventh state 270 may be disabled and the controller of the charging unit 101 may be arranged to enter an eighth state 280.

The controller of the charging unit 101 may be arranged to remain in the eighth state 280 until either the aerosol provision device 100 is removed from the charging unit 101 or if the session is stopped or is otherwise no longer active.

In the situation where the aerosol provision device 100 is removed from the charging unit 101 then the controller of the charging unit 101 may revert back to the sixth state 260 (i.e. the charging unit 101 is not electrically connected to the aerosol provision device and wherein no session has been commenced). In the situation where the session is stopped or is no longer active, but the aerosol provision device 100 remains inserted within the charging unit 101 and wherein the aerosol provision device 100 remains electrically connected to the charging unit 101, then the controller of the charging unit 101 may revert back to the seventh state 270 (i.e. wherein the aerosol provision device 100 is inserted into the charging unit 101 but wherein no session of use is being performed).

According to various embodiments criteria which may be used to determine a non-active session include that the session has been ended (or is desired to be ended) by a user actuating one or more buttons 106 on the aerosol provision device 100 and/or one or more buttons on the charging unit 101. Another criteria for determining that a session is non-active or is otherwise desired to be stopped includes that a determination is made by the controller of the charging unit 101 and/or the controller of the aerosol provision 100 that either the battery of the aerosol provision device 100 and/or the battery of the charging unit 101 has been depleted.

With reference to the flowcharts shown in both FIGS. 2 and 3, it will be understood that when the controller of the aerosol provision device 100 is in the first state 210 (i.e. when the aerosol provision device 100 is not located in the charging unit 101 and wherein no session has been commenced) then the controller of the charging unit 101 will be in the sixth state 260 (i.e. the charging unit 101 is not electrically connected to the aerosol provision device 100 and wherein no session has been commenced).

When the controller of the aerosol provision device 100 is in the second state 220 (i.e. wherein the aerosol provision device 100 is inserted into the charging unit 101 but no session has yet been commenced), then the controller of the charging unit 101 will be in the seventh state 270 (i.e. wherein the aerosol provision device 100 is inserted into the charging unit 101 but wherein no session of use has yet been commenced). In this situation, with the charging cable plugged in, if it is determined that the battery in the aerosol provision device 100 is below an acceptable threshold criterion, then the battery of the aerosol provision device 100 may be recharged via a charging cable. If it is determined that the battery of the charging unit 101 is below an acceptable threshold criterion, then the battery of the charging unit 101 may also be recharged via the charging cable.

Alternatively, when the controller of the aerosol provision device 100 is in the second state 220 (i.e. wherein the aerosol provision device 100 is inserted into the charging unit 101 but no session has yet been commenced), and the controller of the charging unit 101 is in its corresponding seventh state 270 (i.e. wherein the aerosol provision device 100 is inserted into the charging unit 101 but wherein no session of use has yet been commenced), and it is determined by the controller of the charging unit 101 that no charging cable has been inserted into the charging unit 101 and if it is determined that the battery in the aerosol provision device 100 is below an acceptable threshold criterion, then the battery of the aerosol provision device 100 may be charged via the battery of the charging unit 101.

Finally, when the controller of the aerosol provision device 100 is in the fourth state 240, then the controller of the charging unit 101 may be in the eighth state 280.

According to various embodiments when the aerosol provision device 100 is inserted into the charging unit 101, the controller of the charging unit 101 may act as a master controller. That is, the controller of the charging unit 101 may control energy transfer to the heating element of the aerosol provision device 100 during a session of use. If during the same session the aerosol provision device 100 is removed from the charging unit 101, the controller of the aerosol provision device 100 may then act as the master controller for the aerosol provision device 100 (e.g. in the third state 230 wherein the aerosol provision device 100 is not inserted into the charging unit 101 but a session has nonetheless been commenced) and will substantially immediately control the battery of the aerosol provision device 100 to transfer energy to the heating element of the aerosol provision device 100 in a substantially seamless manner.

According to various embodiments, the system may also comprise a notification unit configured to provide a notification to the user in response to the battery level or current capacity of the battery of the aerosol provision device 100 being insufficient to complete the session of use. The notification may be a haptic notification. Alternatively, the notification may be displayed via the user interface 108.

It will be appreciated that the above process can also happen in reverse i.e. when in the third state 230 (i.e. wherein the aerosol provision device 100 is not inserted into the charging unit 101 but a session has nonetheless been commenced), and the aerosol provision device 100 is then inserted back into the charging unit 101, the controller of the charging unit 101 may act as the master controller for the aerosol provision device 100. Once inserted, the controller of the charging unit 101 may substantially immediately enter the eighth state 280 and energy from the battery of the charging unit 101 may be supplied to the heating element located in the aerosol provision device 100 in order to heat the heating element.

The above-described interchangeable master/slave relationship allows use of the battery of the charging unit 101 to be prioritized whenever possible. The battery of the charging unit 101 may have a larger maximum capacity than the maximum capacity of the battery of the aerosol provision device 100. As a result, the lifetime of battery of the aerosol provision device 100 can be extended as long as possible as e.g. the total number of cycles of the battery of the aerosol provision device 100 can be kept to a minimum.

In addition, the ability for the heating element of the aerosol provision device 100 to draw power from the battery of the aerosol provision device 100 (when not inserted in the charging unit 101) or from the battery of charging unit 101 (when the aerosol provision device 100 is inserted into the charging unit 101) substantially immediately and in an uninterrupted manner allows a seamless transition for the user if the user decides to use the aerosol provision device 100 separate from the charging unit 101 or if the aerosol provision device is subsequently inserted into the charging unit 101 during a session of use.

Alternatively, according to various embodiments, the aerosol provision device may be in the third state 230 (i.e. wherein the aerosol provision device 100 is not inserted into the charging unit 101 but a session of use has been commenced), and the battery of the aerosol provision device 100 transfers energy to the heating element of the aerosol provision device. In the third state 230, the controller of the aerosol provision device 100 may log the battery level or current battery capacity of the aerosol provision device 100.

The aerosol provision device 100 may be inserted into the charging unit 101 during the session of use to be electrically connected to the charging unit 101. This corresponds to the controller of the aerosol provision device 100 being in the fourth state 240 wherein the aerosol provision device 100 is inserted into the charging unit 101 and a session of use is commenced.

In this embodiment, the battery of the aerosol provision device 100 will continue to transfer energy to the heating element of the aerosol provision device 100. This corresponds to the fourth state and the battery of the aerosol provision device 100 transfers energy to the heating element of the aerosol provision device 100. By continuing to energize from the first electrical energy source, the likelihood of the session of use being interrupted (e.g. in the event of an unsuccessful transfer from energizing with the first energy unit to energizing with the second energy unit) may be reduced.

When the aerosol provision device 100 is inserted into the charging unit 101 during a session of use and the battery of the aerosol provision device 100 has continued to supply energy to the heating element of the aerosol provision device 100, the controller of the aerosol provision device 100 and/or the controller of the charging unit 101 may be arranged to log regularly the battery level or current capacity of the battery of the aerosol provision device 100. The controller of the aerosol provision device 100 or the controller of the charging unit 101 may determine when the battery level or current capacity of the battery of the aerosol provision device 100 reaches a predetermined shutdown threshold.

In various embodiments, where it is determined that the battery level or current capacity of the battery of the aerosol provision device 100 has reached the predetermined shutdown threshold, the battery of the aerosol provision device 100 has sufficient energy at the shutdown threshold to permit the controller of the aerosol provision device 100 to perform charging communications with the charging unit 101. The session of use may continue during the time that charging communications are being performed.

In alternative embodiments, where it is determined that the battery level or current capacity of the battery of the aerosol provision device 100 has reached the predetermined shutdown threshold, the controller of the aerosol provision device 100 and/or the controller of the charging unit 101 may immediately control the battery of the charging unit 101 to supply energy to the heating element located in the aerosol provision device 100 to commence a further session of use. The change in supply of energy to the heating element from the battery of the aerosol provision device 100 to the battery of the charging unit 101 may occur in a substantially seamless manner so that a session of use is not interrupted for the user.

The controller of the aerosol provision device 100 or the controller of the charging unit 101 may be arranged to determine and/or log regularly the battery level or current capacity of the battery of the charging unit 101 in response to the further session of use being commenced. In a situation during the further session of use when the battery level or current capacity of the battery of the charging unit 101 is determined to be below a predetermined shutdown threshold, the controller of the aerosol provision device 100 or the controller of the charging unit 101 may control the battery of the aerosol provision device 100 to transfer energy to the heating element of the aerosol provision device 100.

In various embodiments, the aerosol provision system may additionally comprise a notification unit. The notification unit may be configured to provide a notification to the user in response to the battery level or current capacity of the battery of the aerosol provision device 100 being insufficient to complete the session of use. The notification may be, for example, a vibration of the aerosol provision device and/or the charging unit, a notice on a charging unit user interface or other notification means to communicate with the user.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

What is claimed:

1. An aerosol provision system comprising:
an aerosol provision device comprising a first controller and a first electrical energy storage device;
a charging unit for charging the aerosol provision device, the charging unit comprising a second controller and a second electrical energy storage device;
wherein the first controller and/or the second controller is arranged to determine a connection status between the aerosol provision device and the charging unit and to cause the aerosol provision device to enter into a mode of operation;
wherein if the first controller determines that the aerosol provision device is not electrically connected to the charging unit then the first controller is arranged to cause the aerosol provision device to enter a first mode of operation wherein the aerosol provision device is energised by the first electrical energy storage device in order to commence a first session of use at a time t3;
wherein the first controller and/or the second controller is arranged to determine that the aerosol provision device is then subsequently electrically connected to the charging unit at a later time t4 during the first session of use and then to cause the aerosol provision device to be at least partially energised by the second electrical energy storage device in order to continue and optionally complete the first session of use;
wherein the first controller and/or the second controller is further arranged:
(i) to determine that the first session of use has been completed;
(ii) to determine that the aerosol provision device is electrically connected to the charging unit;
(iii) to determine that it is desired to perform a second session of use; and
(iv) to determine if the first electrical energy storage device and/or the second electrical energy storage device comprises sufficient electrical energy in order to energise the aerosol provision device in order to commence and complete a second session of use.

2. An aerosol provision system as claimed in claim 1, wherein the first controller and/or the second controller is further arranged to cause the aerosol provision device to enter into a mode of operation wherein:
if the first controller and/or second controller determines that the aerosol provision device is electrically connected to the charging unit then the first controller and/or second controller is arranged to cause the aerosol provision device to enter a second mode of operation wherein the aerosol provision device is energised by the second electrical energy storage device in order to commence a first session of use at a time t1;
further wherein the first controller is further configured to determine that the aerosol provision device is then subsequently electrically disconnected from the charging unit at a later time t2 during the first session of use and then to cause the aerosol provision device to be energised by the first electrical energy storage device.

3. An aerosol provision system as claimed in claim 1, wherein the first controller and/or the second controller is further arranged to cause the aerosol provision device to enter into a mode of operation wherein:
if the first controller determines that the aerosol provision device is not electrically connected to the charging unit then the first controller is arranged to cause the aerosol provision device to enter a third mode of operation wherein the aerosol provision device is energised by the first electrical energy storage device in order to commence a session of use;
further wherein if the first controller and/or second controller determines that the aerosol provision device is electrically connected to the charging unit at a later time during the session of use, the first controller is arranged to control the first electrical energy storage device to continue energising the aerosol provision device.

4. An aerosol provision system as claimed in claim 2, wherein the system further comprises a notification unit configured to provide a notification to a user in response to the first electrical energy storage device having insufficient energy to complete the first session of use.

5. An aerosol provision system as claimed in claim 4, wherein the notification unit provides the notification to the user when the first session of use is commenced at the time t1.

6. An aerosol provision system as claimed in claim 1, wherein the first controller is further arranged:
(i) to determine that the aerosol provision device is then subsequently electrically disconnected from the charging unit at a later time t5 during the first session of use; and
(ii) to cause the aerosol provision device to be energised by the first electrical energy storage device.

7. An aerosol provision system as claimed in claim 6, wherein the first controller and/or the second controller is further arranged:
(i) to determine that the aerosol provision device is then subsequently electrically re-connected to the charging unit at a later time t6 during the first session of use; and
(ii) to cause the aerosol provision device to be at least partially energised by the second electrical energy storage device in order to continue the first session of use.

8. An aerosol provision system as claimed in claim 7, wherein t6 > t5 > t4 > t3.

9. An aerosol provision system as claimed in claim 1, wherein the first controller is further arranged:
(i) to determine that the first session of use has been completed;
(ii) to determine that the aerosol provision device is electrically disconnected from the charging unit;
(iii) to determine that it is desired to perform a second session of use; and
(iv) to determine if the first electrical energy storage device comprises sufficient electrical energy in order to energise the aerosol provision device in order to commence and optionally complete a second session of use.

10. An aerosol provision system as claimed in claim 2, wherein, when the first electrical energy storage device energises the aerosol provision device and the aerosol provision device is electrically connected to the charging unit, the first controller or the second controller is configured to terminate the first session of use when the charge level of the first electrical energy storage device reaches a shutdown threshold.

11. An aerosol provision system as claimed in claim 10, wherein the first electrical energy storage device has sufficient energy at the shutdown threshold to permit the first controller to perform charging communications with the charging unit.

12. An aerosol provision system as claimed in claim 2, wherein when the first electrical energy storage device energises the aerosol provision device and the aerosol provision device is connected to the charging unit, the first controller or the second controller is configured to control the second electrical energy storage device to energise the aerosol provision device when a charge level of the first electrical energy storage device reaches a shutdown threshold.

13. An aerosol provision system as claimed in claim 2, wherein the first controller or the second controller is configured to determine a charge level of the second electrical energy storage device in response to a further session of use being commenced.

14. An aerosol provision system as claimed in claim 13, wherein in response to the second electrical energy storage device having a charge level above a threshold, the first controller or the second controller is configured to control the second electrical energy storage device to energise the aerosol provision device in the further session of use.

15. An aerosol provision system as claimed in claim 13, wherein in response to the second electrical energy storage device having a charge level below the threshold, the first controller or the second controller is configured to control the first electrical energy storage device to energise the aerosol provision device in the further session of use.

16. An aerosol provision system as claimed in claim 1, wherein the first controller and/or the second controller is further arranged to cause the aerosol provision device to enter into a mode of operation, wherein if the first controller and/or second controller determines that the aerosol provision device is electrically connected to the charging unit then the first controller and/or second controller is arranged to cause the aerosol provision device to enter a fourth mode of operation wherein the aerosol provision device is energised by the second electrical energy storage device in order to commence and optionally complete a first session of use.

17. An aerosol provision system as claimed in claim 1, wherein the first controller and/or the second controller is further arranged to cause the aerosol provision device to enter into a mode of operation wherein if the first controller determines that the aerosol provision device is not electrically connected to the charging unit then the first controller is arranged to cause the aerosol provision device to enter a fifth mode of operation wherein the aerosol provision device is energised by the first electrical energy storage device.

18. A method of operating an aerosol provision system comprising:
providing an aerosol provision device comprising a first controller and a first electrical energy storage device;
providing a charging unit for charging the aerosol provision device, the charging unit comprising a second controller and a second electrical energy storage device; and
arranging for the first controller and/or the second controller to determine a connection status between the aerosol provision device and the charging unit and to cause the aerosol provision device to enter into a mode of operation wherein if the first controller determines that the aerosol provision device is not electrically connected to the charging unit then the method further comprises arranging for the first controller to cause the aerosol provision device to enter a first mode of operation wherein the aerosol provision device is energised by the first electrical energy storage device in order to commence a first session of use at a time t3;
further wherein the method further comprises arranging the first controller and/or the second controller to determine that the aerosol provision device is then subsequently electrically connected to the charging unit at a later time t4 during the first session of use and then to cause the aerosol provision device to be at least partially energised by the second electrical energy storage device in order to continue and optionally complete the first session of use;
wherein the method further comprises arranging the first controller and/or the second controller:
(i) to determine that the first session of use has been completed;
(ii) to determine that the aerosol provision device is electrically connected to the charging unit;
(iii) to determine that it is desired to perform a second session of use; and
(iv) to determine if the first electrical energy storage device and/or the second electrical energy storage device comprises sufficient electrical energy in order to energise the aerosol provision device in order to commence and complete a second session of use.

19. An aerosol provision device comprising a first controller and a first electrical energy storage device wherein the aerosol provision device is connectable, in use, to a charging unit for charging the aerosol provision device, the charging unit comprising a second controller and a second electrical energy storage device;
wherein the first controller and/or the second controller is arranged to determine a connection status between the aerosol provision device and the charging unit and to cause the aerosol provision device to enter into a mode of operation wherein if the first controller determines that the aerosol provision device is not electrically connected to the charging unit then the first controller is arranged to cause the aerosol provision device to enter a first mode of operation wherein the aerosol provision device is energised by the first electrical energy storage device in order to commence a first session of use at a time t3;
further wherein the first controller and/or the second controller is arranged to determine that the aerosol provision device is then subsequently electrically connected to the charging unit at a later time t4 during the first session of use and then to cause the aerosol provision device to be at least partially energised by the second electrical energy storage device in order to continue and optionally complete the first session of use;
wherein the first controller and/or the second controller is further arranged:
(i) to determine that the first session of use has been completed;
(ii) to determine that the aerosol provision device is electrically connected to the charging unit;
(iii) to determine that it is desired to perform a second session of use; and
(iv) to determine if the first electrical energy storage device and/or the second electrical energy storage device comprises sufficient electrical energy in order to energise the aerosol provision device in order to commence and complete a second session of use.

20. A charging unit comprising a second controller and a second electrical energy storage device wherein the charging unit is connectable, in use, to an aerosol provision device for charging the aerosol provision device, the aerosol provision device comprising a first controller and a first electrical energy storage device;
wherein the first controller and/or the second controller is arranged to determine a connection status between the aerosol provision device and the charging unit and to cause the aerosol provision device to enter into a mode of operation wherein if the first controller and/or the second controller determines that the aerosol provision device is not electrically connected to the charging unit then the first controller is arranged to cause the aerosol provision device to enter a first mode of operation wherein the aerosol provision device is energised by the first electrical energy storage device in order to commence a first session of use at a time t3;
wherein the first controller and/or the second controller is arranged to determine that the aerosol provision device is then subsequently electrically connected to the charging unit at a later time t4 during the first session of use and then to cause the aerosol provision device to be at least partially energised by the second electrical energy storage device in order to continue and optionally complete the first session of use;
wherein the first controller and/or the second controller is further arranged:
(i) to determine that the first session of use has been completed;
(ii) to determine that the aerosol provision device is electrically connected to the charging unit;
(iii) to determine that it is desired to perform a second session of use; and
(iv) to determine if the first electrical energy storage device and/or the second electrical energy storage device comprises sufficient electrical energy in order to energise the aerosol provision device in order to commence and complete a second session of use.
